(19) United States
(12) Patent Application Publication
(10) Pub. No.: US 2020/0402119 A1
(43) Pub. Date: Dec. 24, 2020

(54) CANNABIS PRODUCT PRICE COMPARISON & INFORMATION APPLICATION

(71) Applicant: Andrew Moore, Denver, CO (US)

(72) Inventor: Andrew Moore, Denver, CO (US)

(21) Appl. No.: 16/449,352

(22) Filed: Jun. 22, 2019

(51) Int. Cl. G06Q 30/02; G06Q 20/20; G06Q 30/06

(52) U.S. Cl. CPC G06Q 30/0282; G06Q 30/0623; G06Q 30/0641; G06Q 20/201

(57) ABSTRACT

The present invention provides app users the ability to view and share prices for popular products sold in cannabis dispensaries. Users can also submit and view reviews for each dispensary. The map feature allows users the ability to quickly view prices.

### FIELD OF THE INVENTION

The present invention relates to the field of price comparison applications system, and in particular, price comparisons for products offered for sale in dispensaries for mobile computing devices such as smartphones and tablets.

### BACKGROUND

Cannabis dispensaries are part of a new market. Cannabis for medical patients is providing natural treatment for various illnesses like seizures, nausea, and glaucoma to name a few, with reduced side effects prevalent in conventional medicines. Much of this new industry is heavily regulated. For example, many states require that dispensaries must advertise to audiences that they know will be at least 70% over the age of 21—a prudent rule to protect minors. Another example is the requirement that all windows must be blacked-out and no price or other product information displayed outside the four walls of the dispensary. These laws restrict the ability of many dispensaries from educating consumers about various products.

Because the cannabis market is growing and because the cannabis market is heavily regulated, many dispensaries work around advertising and product information sharing regulations via mobile computing devices such as smartphones and tablets. Dispensaries can be more confident that the app user is the proper age by requiring age verification alerts in a mobile app. Because consumers are uninformed about many of the products offered for sale in dispensaries a mobile app is a convenient resource to learn about product information. The alternative requires consumers to physically enter a dispensary to learn about product information. Consumers are demanding convenient and additional information in this new and rapidly growing market. Consumers want updated information that is easy to access in a user-friendly interface. While there are some inventions like the present invention, they however, leave gaps in the information that consumers demand.

For example, one app called Weedmaps provides users with dispensary locations on a map, among other things. While this feature allows users to find dispensary locations, the time it takes to find scattered prices takes too long and it is difficult to easily compare the price of the products. A Weedmaps user must tap into each dispensary icon and then continue tapping into the menu function in order to discover the prices for various products. The user must then also tap the back button to navigate back to the map feature in order to discover the prices of a nearby dispensary. In a nutshell, the process is burdensome and time consuming.

Another app called Wikileaf provides users with dispensary locations on a map and dispensary locations in a scrollable table format. However, Wikileaf is distinguished from Weedmaps because each dispensary location icon has a flower price ranging from 1 gram to 1 ounce. Users can filter the prices based on the amount of flower. While Wikileaf seemingly solved the burdensome and time consuming process of searching for flower prices, Wikileaf left some gaps in the amount of information that users demand. For instance, dispensaries sell things other than flower. Dispensaries sell vaporizer cartridges, concentrates like wax, shatter, and butter, edibles like baked goods, gummy candies, tinctures, and even cannabis infused soda. The cannabis market has expanded from only flower. Also, Wikileaf s prices are incomplete—some dispensaries do not have prices listed. And the prices that are listed may be outdated prices.

Both Weedmaps and Wikileaf users must tap several buttons in order to discover price information for the other products sold in dispensaries. Consumers are left with the same problem of slow and inconvenient price searching. Additionally, app users and consumers must rely on the prices to be provided by the dispensary. It seems that if a dispensary does not work together with the app company that a user will not know what products are offered at the dispensary. Moreover, it is difficult to know whether the price shown is an updated price. Cannabis prices like other commodities can fluctuate quickly based on a variety of factors such as laws, regulation, overhead, supply and demand, product type and quality, among others. The existing apps do not make it clear to the user if they are viewing updated price information. Moreover, the prices shown do not necessarily reflect whether the price is part of a special offer, deal, or membership through the dispensary. Savvy consumers lack updated information.

PriceOfWeed.com is website where users can enter and share flower price information. The problem with this website is that the price information provided is for the street value of cannabis flower, and not necessarily for licensed dispensaries. The information does not directly help a consumer make an informed shopping decision at a licensed location. Also, the website only shows flower prices, not other cannabis products, and the website only shows prices for regions and not individual dispensaries. Consumers still don't know what price to expect between two nearby dispensaries.

Lastly, there is no mobile app where users submit and share cannabis price information. Consumers can fill in the price information gap to help other users compare prices. Consumers currently do not have the ability to supply crowdsourced pricing information via a convenient and user-friendly mobile computing system to solve their own lack of price information problem. That is, until now.

### BRIEF SUMMARY OF THE INVENTION

The present invention comprises a novel mobile application that allows users to primarily submit prices of products sold in dispensaries and submit reviews for the same. Users can also view other reviews and compare price submissions against other dispensaries. Additionally, users can view the menu of products offered for sale by each dispensary, submit and view reviews for each dispensary, and view locations and product prices for each dispensary on a map. Users may share a dispensary's description and image with other users, plot a route from their current location to each dispensary, and bookmark each dispensary for quick reference any time the user opens the app. The present invention solves the problems of incomplete or outdated price information for more than flower, which are unsolved problems in other mobile applications.

### BRIEF DESCRIPTION OF THE DRAWINGS

The present invention is illustrated in the accompanying drawings, throughout which like reference letters indicate corresponding parts in the various figures. The embodiments herein will be better understood from the following description with reference to the screenshots/drawings, in which:

FIG. 1—FIG. 1 illustrates various embodiments of the app including an alert requiring users to confirm ability to use app, a table with a list of places, a search bar, price display, and a bookmark button to filter favorite places. FIG. 1 also illustrates various embodiments of the app including a map, and buttons that link to the world wide web.

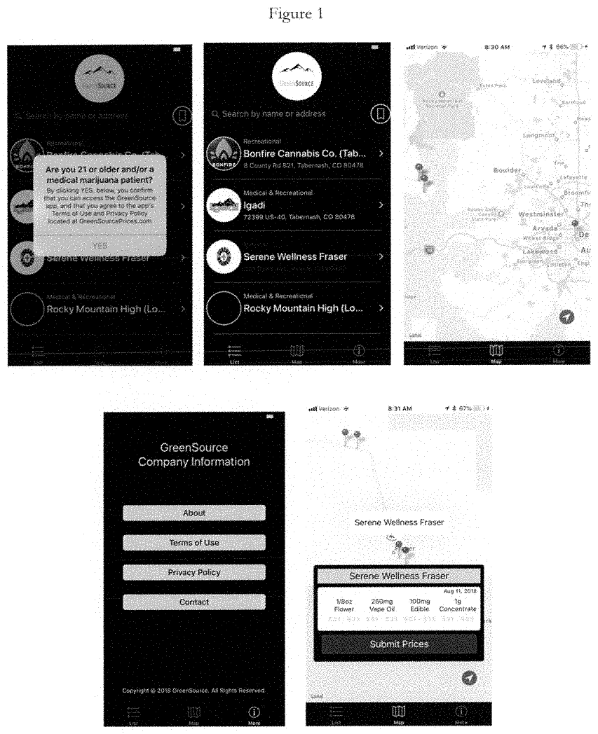

FIG. 2—FIG. 2 illustrates various embodiments of the details for a particular place that is selected by the user such as a prices display, price submit button and functions, reviews display, review submit button and functions, and menu display.

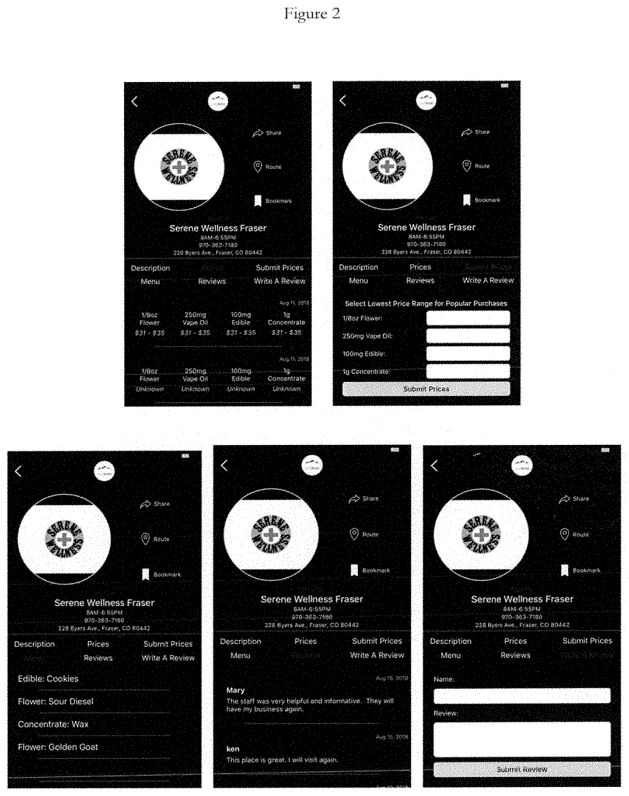

FIG. 3—FIG. 3 illustrates further details of the various embodiments of FIG. 2 such as the bookmark button and function, a button and function for sharing information, and button and functions to plot directions to a dispensary on a map.

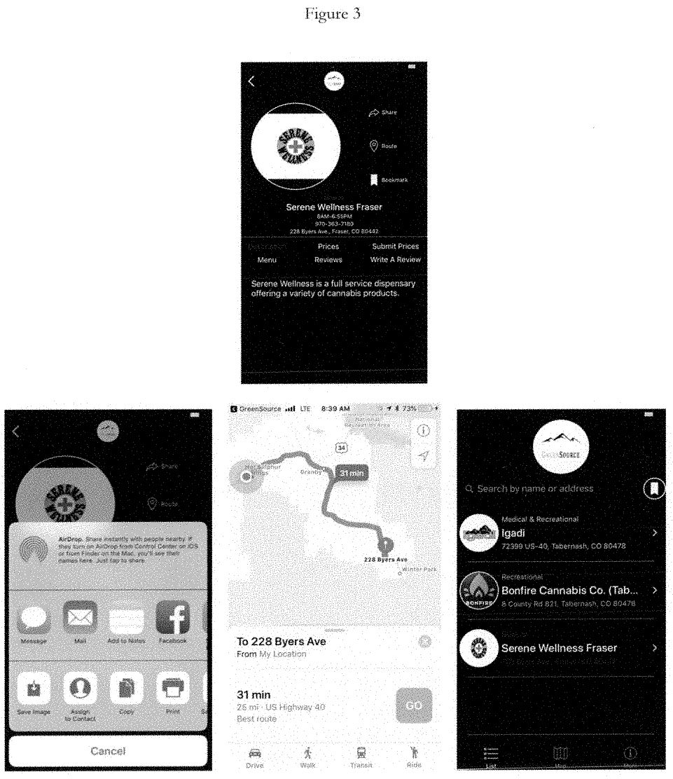

### DETAILED DESCRIPTION OF THE INVENTION

The following detailed description contains specific details that are set forth to provide a comprehensive understanding of the present invention. Although the following detailed description contains many specifics for the purposes of illustration, anyone of ordinary skill in the art will appreciate that many variations and alterations to the following details are within the scope of the invention.

The present invention can be implemented on any communication device that has hardware components that can perform telecommunication such as (but not limited to)—computers (desktop, laptop, tablets), smart phones, personal multimedia devices, etc. . . . .

The various devices on which the applications that implement the present invention run may use one or more processors with different instruction-sets, architectures, clock-speeds, etc. and memory that may include high speed random access memory and may include non-volatile memory such as one or more magnetic disk storage devices, flash memory devices and other kinds of solid state memory devices.

The various applications that can implement the present invention run on electronic devices that may use at least one physical user interface device that provide the means of control and navigation within the operating system and applications that run on the devices include (but not limited to) touch-pads such as those described in (but not limited to)—(1) U.S. patent application Ser. No. 10/722,948 (“Touch pad for handheld device”, filed Nov. 25, 2003); (2) U.S. patent application Ser. No. 10/188,182 (“Touch, pad for handheld device”, filed Mar. 21, 2006); (3) U.S. patent application Ser. No. 08/210,610 (“Computer system with touchpad support in operating system”, filed Mar. 18, 1994); (4) U.S. patent application Ser. No. 643,256 (“Movable touch pad with added functionality”, filed Ser. No. 10/643,256), touch screens such as those described in (but not limited to) (1) U.S. patent application Ser. No. 11/381,313, “Multipoint Touch Surface Controller,” filed on May 2, 2006; (2) U.S. patent application Ser. No. 10/840,862, “Multipoint Touchscreen,” filed on May 6, 2004; (3) U.S. patent application Ser. No. 10/903,954, “Gestures For Touch Sensitive Input Devices,” filed on Jul. 30, 2004; (4) U.S. patent application Ser. No. 11/048,264, “Gestures For Touch Sensitive Input Devices,” filed on Jan. 31, 2005; (5) U.S. patent application Ser. No. 11/038,590, “Mode-Based Graphical User Interfaces For Touch Sensitive Input Devices,” filed on Jan. 18, 2005; (6) U.S. patent application Ser. No. 11/228,758, “Virtual Input Device Placement On A Touch Screen User Interface,” filed on Sep. 16, 2005; (7) U.S. patent application Ser. No. 11/228,700, “Operation Of A Computer With A Touch Screen interface,” filed on Sep. 16, 2005; (8) U.S. patent application Ser. No. 11/228,737, “Activating Virtual Keys Of A Touch-Screen Virtual Keyboard,” filed on Sep. 16, 2005 and (9) U.S. patent application Ser. No. 11/367,749, “Multi-Functional Hand-Held Device,” filed on Mar. 3, 2006, click wheel such as those described in U.S. patent application Ser. No. 11/549,619 “Method, device, and graphical user interface for dialing with a click wheel” filed on Oct. 13, 2006, keyboards such as those mentioned in (but not limited to) U.S. patent application Ser. No. 07/711,760 (“Ergonomic keyboard input device”, filed on Jun. 6, 1991), mouse such as those described in (but not limited to) (1) application Ser. No. 09/167,314 (“Computer mouse with enhance control button (s)”, filed on Oct. 6, 1998); (2) application Ser. No. 08/288,945 (“Roller mouse for implementing scrolling in windows applications”, filed on Aug. 10, 1994) and gesture recognition means such as those described in (but not limited to) (1) European Patent application publication number: EP2482176 A2 (“Multi-input gesture control for a display screen”, filed on Nov. 4, 2011) and (2) patent application with publication number 20120317511 A1 (“DISPLAY WITH BUILT IN 3D SENSING CAPABILITY AND GESTURE CONTROL OF TV”, filed on Aug. 21, 2012).

Display means used by these devices may use LCD (liquid crystal display) technology, LED (light Emitting Diode) technology, CRT (Cathode ray tube) technology, or LPD (light emitting polymer) technology or any other display technologies. Various realizations of graphics display circuitry that implement a Graphics Processing Unit (GPU) are used to achieve video interface between user and these electronic devices.

Connectivity of these devices with networks such as the internet, an intranet and/or wireless network such as cellular telephone network, a wired or wireless local area network (LAN) and/or metropolitan area network (MAN) and/or WAN (wide area network) and other wireless communication is achieved by use of a plurality of communication standards, protocols and technologies like Global System for mobile communication (GSM), Enhanced Data GSM Environment (EDGE), wideband code division, of multiple access (W-CDMA), DLNA, LTE (Long Term Evolution), code division of multiple access (CDMA), time division multiple access (TDMA), Bluetooth, Wireless Fidelity (Wi-Fi) and/or any other suitable communication protocol, including communication protocols not yet developed as of the filing date of this document.

The present invention may be implemented on applications that run on a single or variety of operating system platforms including but not limited to OS X, WINDOWS, UNIX, IOS, ANDROID, SYMBIAN, LINUX, or embedded operating systems such as VxWorks.

The present invention may also be implemented to work with various web browsers including but not limited to Internet Explorer, Mozilla Firefox, Safari and Opera that access and handle various types of web pages constructed with various mark-up languages such as HTML, HTML-5, XHTML, XML, etc. and the associated CSS (cascading style sheet) files and java-script files.

The method implements a Graphical User Interface operable with the means for control and navigation of the user's communication device that enables the user to use the various means provided through the system.

The invention primarily provides a computer-implemented method for submitting prices of dispensary products and reviews from a mobile price comparison system stored in the non-transitory storage medium of an electronic device like mobile phones or smart phones, etc. . . . .

Further, the method of sending one or more prices and/or reviews from a mobile pricing and reviews system stored in the non-transitory storage medium comprises of a centralized database and a plurality of mobile devices. Furthermore, the centralized database receives data entered by the user generated at a primary mobile device, the primary data request comprising metadata of information provided by a primary mobile device to be delivered; a plurality of mobile devices thereafter extracts the metadata based on the primary data request, the extracted metadata including information for delivering the primary data from the mobile pricing system; a plurality of primary data to a plurality of secondary mobile devices capable of telecommunication is sent, which is received at a plurality of secondary mobile devices, other metadata stored in the database can be received by a plurality of mobile devices.

Further in yet another embodiment of the invention, a map is displayed with location pins or annotations at various locations. The annotations can be clicked on or tapped by a user. Once a pin is clicked on or tapped it will display data, which is sent to and received from the centralized database. The map also includes a geolocate button with privacy settings for the user.

Additionally, in one embodiment of the invention, a scrollable table of information is provided. The search bar can be used to filter the list of information. The information can be tapped/clicked. Once the information is tapped/clicked, more and new information will be displayed.

Additionally in one embodiment of the invention, the mobile pricing system comprises a mobile computing device, wherein the mobile computing device wirelessly communicates with other mobile computing devices.

Additionally, in one embodiment of the invention, the mobile pricing system presents access to the World Wide Web when various buttons are tapped/clicked.

Additionally, in one embodiment of the invention, the mobile pricing system presents options when the share button is tapped/clicked. The user can send and share information via social media, text, email, make a note, save PDF to iBooks, save an image, assign to contact, copy, print, save to files, and more.

Additionally, in one embodiment of the invention, the mobile pricing system presents a mapping and directions feature when the route button is tapped/clicked. The user can get directions from their current location to a dispensary location.

Additionally, in one embodiment of the invention, the mobile pricing system presents a bookmark feature when the bookmark button is tapped/clicked. The user can tap/click the bookmark button to save the dispensary as a favorite and access the bookmarked dispensary more quickly at a later time. A dispensary that is bookmarked can be filtered in the table/list feature of the app when the user taps/clicks the bookmark button.

The present invention could be used in the following ways, including, but not limited to:
1. Providing access to premium content like news articles and various specials or deals being offered, deliveries, strain information, rewards, incentives, ordering services, access to medical doctors, social media, photos;
2. Automatically update the information that a user would provide by a remote censor when a mobile computing device is near the censor;
3. Scrollable price submissions could be replaced with one price display for the day that the prices are viewed, and omit previous prices;
4. Obtaining email addresses or other personal contact information in order to communicate with app users.

### CROSS REFERENCE TO RELATED APPLICATIONS

I claim the benefit of an earlier filed provisional application with the following identification information:

a. Title: Dispensary Product Price Comparison & Information App;

b. Provisional Application No.: 62/719,763;

c. Filing Date: Aug. 20, 2018;

d. Name of Applicant: Andrew Moore, Fraser, CO; and

e. Confirmation No.: 1075.

1. A computer-implemented apparatus comprising:
1. a method of submitting prices of cannabis products and reviews, including but not limited to said products in dispensaries, from a price comparison system stored in the non-transitory storage medium of an electronic device like mobile phones or smart phones or tablets etc. . . . said method comprising of the sending of one or more prices and/or reviews from a mobile pricing and reviews system stored in the non-transitory storage medium comprised of a centralized database and a plurality of mobile devices; the centralized database receives data entered by the user generated at a primary mobile device; the primary data request comprising metadata of information provided by a primary mobile device to be delivered from the database; a plurality of mobile devices thereafter extracts the metadata based on the primary data request; the extracted metadata including information for delivering the primary data from the mobile pricing system; a plurality of primary data to a plurality of secondary mobile devices capable of telecommunication is sent, which is received at a plurality of secondary mobile devices; other metadata stored in the database can be sent and received by a plurality of mobile devices in a similar manner; collecting tracking data submitted and shared by users as well as data added to the database by an administrator within the remote communication system; updating the metadata stored persistently in the database based on the tracking date and other criteria.
2. The method of claim 1, wherein the price comparison and reviews system comprises a computing device, wherein the computing device wirelessly communicates with the remote communication system, a plurality of mobile devices and a database.
3. The method of claim 1, wherein the extracted metadata include the following but are not limited to at least one of price content, review and name content, dates, latitude and longitude, place names, place addresses, place hours of business, place phone numbers, types of dispensaries, place menu items, and user contact information, among other things.
4. The method of claim 1, wherein the price comparison system further comprises several dashboards represented in a graphical user interface, wherein the dashboard displays connectivity, a table of places which can be filtered by search bar or bookmarks, a detailed graphical user interface for each place selected with various sub-graphical user interfaces within the general detailed graphical user interface, an interactive map with annotations/map pins that can be tapped for relevant information like prices and/or reviews, and buttons linking users to the world wide web/internet.
5. The present invention could be used in the following ways, including, but not limited to:
a. Providing access to premium content like news articles and various specials or deals being offered, deliveries, strain information, rewards, incentives, ordering services, access to medical doctors, social media, photos, menus;
b. Automatically update the information that a user would provide by a remote censor when a mobile computing device is near the censor;
c. Scrollable price submissions could be replaced with one price display for the day that the prices are viewed, and omit previous prices;
d. Obtaining email addresses or other personal contact information in order to communicate with app users.
